(19) United States
(12) Patent Application Publication
(10) Pub. No.: US 2026/0278476 A1
(43) Pub. Date: Sep. 17, 2026

(54) SYNTHETIC DATA GENERATION FOR PREDICTIVE MODELS

(71) Applicant: Genpact USA, Inc., New York, NY (US)

(72) Inventors: Vipul Sharma, Kolkata (IN); Ishika Shruti, New Delhi (IN); Ish Chaudhary, Bangalore (IN); Tanish Verma, New Delhi (IN); Parimesh Panda, Bangalore (IN); Omprakash Ranakoti, Bangalore (IN); Rajeev N. Ranjan, Bangalore (IN); Sreekanth Menon, Bangalore (IN)

(21) Appl. No.: 19/076,414

(22) Filed: Mar. 11, 2025

(51) Int. Cl. G06N 20/20; G06F 17/40

(52) U.S. Cl. CPC G06N 20/20; G06F 17/40

(57) ABSTRACT

A method and system for generating synthetic data is disclosed. In some embodiments, the method includes receiving data comprising data items and associated features. The method includes performing first clustering to generate a first set of clusters based on similarities and differences of the features, training an ML model using the first set of clusters, receiving a new data item and associated features, and inputting the new data item's features to the trained ML model to output a first cluster to which the new data item is assigned. The method also includes performing second clustering on the first cluster to generate time-series clusters for the data items in the first cluster, calculating a representative time-series data set based on the time-series clusters. The method further includes generating a data signal for the new data item, which is combined with the representative time-series data set to create the synthetic data.

### TECHNICAL FIELD

This disclosure relates to data pre-processing and synthetic data generation for predictive models and, in particular, to systems and methods for generating synthetic training or historical data to enhance the performance of machine learning and forecasting models when limited or no data is available.

### BACKGROUND

Predictive models are widely used in various domains (e.g., autonomous systems, natural language processing, etc.). The performance of predictive models (e.g., machine learning (ML) models, artificial intelligence (AI) models), however, is heavily dependent on the quality, quantity, and diversity of the data the models are trained on. In practical scenarios, any of insufficient data, imbalanced data, or incomplete data may reduce the performance of an AI/ML model. For example, the lack of training data may undermine the capability of a ML model to identify trends, uncover complex relationships, capture data variances, identify anomalies, etc., leading to poor results with reduced prediction accuracy and increased uncertainty. Data augmentation solutions (e.g., synthetic data generation, transfer learning) may be applied to compensate for the data issues and improve model robustness and predication accuracy.

### SUMMARY

To address the aforementioned shortcomings, a method and a system for generating a synthetic data set for use with a predictive model is disclosed herein. In some embodiments, the method receives, at a computing system comprising a processor and a memory, structured electronic data comprising a plurality of data items, wherein each data item comprises a plurality of features. The method performs, by the processor, a first clustering process to generate a first set of clusters based on similarities and differences of the features of the data items. The method trains, by the processor, a machine learning (ML) model using the first set of clusters to predict an assignment of a new data item to a cluster in the first set of clusters. The method receives, at the computing system, a new data item comprising a plurality of features, provides the features of the new data item as input to the trained ML model, and receives as output from the trained ML model a first cluster of the first set of clusters to which the new data item is assigned. The method also performs, by the processor, a second clustering process on the first cluster to generate a plurality of time-series clusters for the data items included in the first cluster, and calculates, by the processor, a representative time-series data set based on the plurality of time-series clusters. The method further generates, by the processor, a data signal representing a trend in a data value over a recent period of time, and constructs the synthetic data set based on the representative time-series data set and the data signal. The data signal may be a time-series sequence representing the recency information for new data (e.g., computer network traffic, or popularity trend of a product).

In some embodiments, to perform the second clustering process, dynamic time warping is applied to generate the plurality of time-series clusters for the data items included in the first cluster. In some embodiments, for each time-series cluster in the plurality of time-series clusters, a first distance is calculated by the processor. The first distance is between the features of the new data item and a representation of the features of the time-series cluster, and the representation includes a mean feature demonstrated by each of the plurality of time-series clusters. In some embodiments, to calculate the representative time-series data set, a weight is assigned to each time-series cluster based on the first distance using a first custom weight function. A mean value of time-series sequences included in each time series cluster is calculated to generate an associated time series for the time-series cluster. The representative time-series data set is generated based on the weight assigned to each time-series cluster and the associated time series calculated for each time series cluster. In some embodiments, to perform the first clustering process, a set of features is identified from the plurality of features associated with the plurality of data items, and the identified features are normalized. A second distance is determined to measure similarity between the features of the new data item and the normalized features of each of the plurality of similar data items, and the plurality of data items is categorized based on the second distance. In some embodiments, a plurality of feature importance scores associated with the features of the data items in the first set of clusters are extracted, and receiving as input from the trained ML model the first cluster to which the new data item is assigned is based on the feature importance scores. In some embodiments, the received data of the plurality of data items is preprocessed. In some embodiments, to construct the synthetic data set, the data signal is rescaled, and the rescaled data signal and the representative time-series data set are combined.

The first clustering process can be a feature-based clustering process, and the second clustering process can be time-series-based clustering process. In some embodiments, the data signal is generated using a second custom weight function.

The above and other preferred features, including various novel details of implementation and combination of elements, will now be more particularly described with reference to the accompanying drawings and pointed out in the claims. It will be understood that the particular methods and apparatuses are shown by way of illustration only and not as limitations. As will be understood by those skilled in the art, the principles and features explained herein may be employed in various and numerous embodiments.

### BRIEF DESCRIPTION OF THE DRAWINGS

The disclosed embodiments have advantages and features that will be more readily apparent from the detailed description, the appended claims, and the accompanying figures (or drawings). A brief introduction of the figures is below.

FIG. 1 illustrates an exemplary high-level process for generating synthetic data, according to some embodiments.

FIG. 2 illustrates an exemplary synthetic data generation system, according to some embodiments.

FIG. 3 illustrates an exemplary server used as part of a system for generating synthetic data using the methods described herein, according to some embodiments.

FIG. 4 illustrates an example framework for generating synthetic data, according to some embodiments.

FIGS. 5A and 5B illustrate an example workflow of generating synthetic demand time series data, according to some embodiments.

FIG. 6 illustrates a flowchart of generating synthetic data, according to some embodiments.

FIG. 7 illustrates a block diagram of an example computer system that may be used in implementing the technology described herein, according to some embodiments.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Overview

Data preparation is the foundation of successful AI models, ML models, and other predictive models, as it ensures the data fed into algorithms is accurate, consistent, and representative of a problem domain. Despite the importance, data preparation remains one of the most challenging and time-consuming aspects of predictive models (e.g., AI/ML models). One of the primary technical difficulties is insufficient data, where many applications lack the volume of labeled data needed to train complex models effectively. Another technical difficulty is noisy or incomplete data, where incomplete records or missing values may skew model training if not handled properly and noisy data (e.g., errors, duplicates, and/or inconsistencies) may make the predictive models hard to learn. Data may also be imbalanced (e.g., when certain classes or categories in a dataset are underrepresented), leading to biased predictions. In specific scenarios (e.g., AI/ML prediction involving new data items), the data used in training predictive models can be insufficient, incomplete, and/or imbalanced, significantly hindering the accuracy and reliability of model prediction.

Data quality, quantity, and diversity issues (e.g., absence of training or historical data) may prevent a predictive or AI/ML model from identifying patterns and relationships between features and outcomes, cause difficulty in creating reasonable baseline predictions or comparison-based models, and/or impact the parameter adjustment in certain systems (e.g., exponential smoothing). For example, existing AI/ML-based methods may lack the ability to apply time-series analysis, since there is no temporal sequence to analyze (e.g., in new data item prediction). It is also hard for existing AI/ML-based methods to obtain meaningful features that represent the underlying characteristics used for model training due to the complexity caused by unpredictable circumstantial conditions. Other methods (e.g., research, surveys, and analogical reasoning) may be applied, but they often yield less reliable results.

Additionally, the technical challenge is compounded by the need to incorporate various external variables and qualitative data into a predictive model (e.g., AI/ML model). An AI/ML model may use the data related to a proxy or analogous data (e.g. when real data cannot be captured or is not available), but such data may not perfectly align with real data characteristics, and thus introduce a level of uncertainty and potential bias in the estimation from the AI/ML model. Exogenous factors (e.g., user sentiment analysis, social media trends, expert opinions, etc.) are often used in an AI/ML model to adjust predictions. However, not only these factors/variables are inherently subjective and vary widely, but the AI/ML model also lacks the ability to understand the interplay between these factors and the prediction (e.g., related to a new data item) due to the technical issues of data provision (e.g., the absence of training data or historical data). It is difficult to synthesize the external information into a cohesive and accurate predictive model.

A data augmentation approach based on synthetic data generation may be employed to underscore the intricacies of AI/ML predictive models and enhance model performance as described hereafter. Synthetic data includes artificially generated data that mimics the statistical properties of real data. Synthetic data may be generated to increase the size of small datasets, providing more training samples. Synthetic data may also create additional samples for underrepresented classes, addressing bias and improving fairness. In certain fields (e.g., robotics, autonomous vehicles), synthetic data may simulate scenarios that are difficult to capture in real life. Moreover, synthetic data enables the creation of data that may not be present in the original dataset but are important for model performance, such as in an extreme or rare scenario or when limited or no available data can be captured.

The present disclosure proposes methods and systems for generating synthetic data for use with predictive models. In some embodiments, the present system may be applied to generate synthetic training data for an AI/ML model. In other embodiments, the present system may be used to generate synthetic data for use with a forecasting model. The present disclosure may be described in the context of some example use cases for brevity and clarity; however, the techniques and approaches described in this disclosure can be applied to any other AI/ML models/contexts. For example, the present synthetic data generation approach for AI/ML models may be used in estimating a specific characteristic of a new data item, estimating the coverage of a computer network security issue, identifying the usage of a newly deployed network/computer equipment in a network environment, etc.

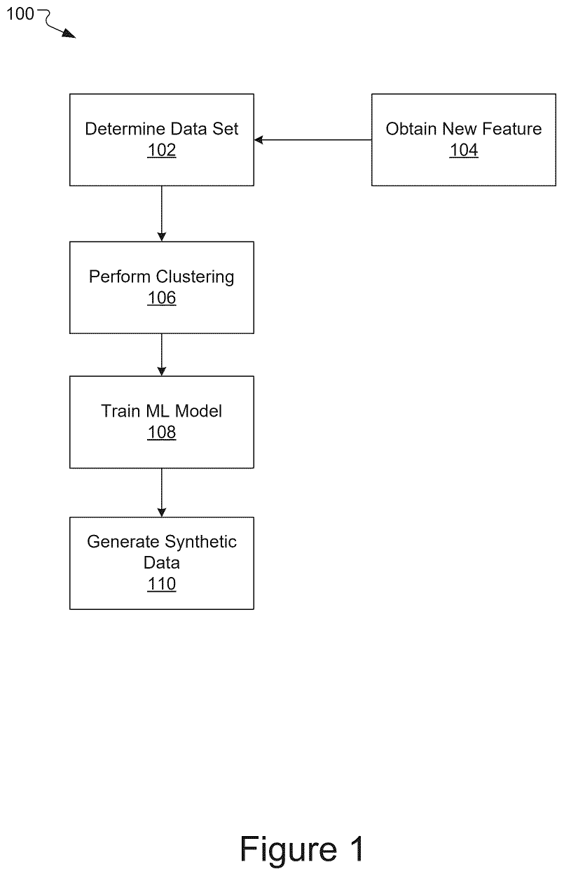

FIG. 1 illustrates an exemplary high-level process 100 for generating synthetic data. The present disclosure may apply process 100 to generate synthetic data to overcome the above-mentioned data limitations, enhance data preparation (e.g., training data fed into an AI/ML model), and improve model training and generalization. As depicted, process 100 may start by determining one or more data sets at step 102. A set of data is processed and used by at least one ML model (e.g., a multiclass classifier) to generate the rich, synthetic data fed into a predictive model. The synthetic data can be training data for an AI/ML model or artificial historical data for a forecasting model. In some embodiments, the data set may include at least a master dataset characterizing a set of data items and another dataset featuring a new data item. At step 104, features of the new data item may be obtained or extracted. In some embodiments, the set may include the data items that share similarities with the new data item. The selection of the data items in the set and the associated master dataset may vary depending on the extracted new features.

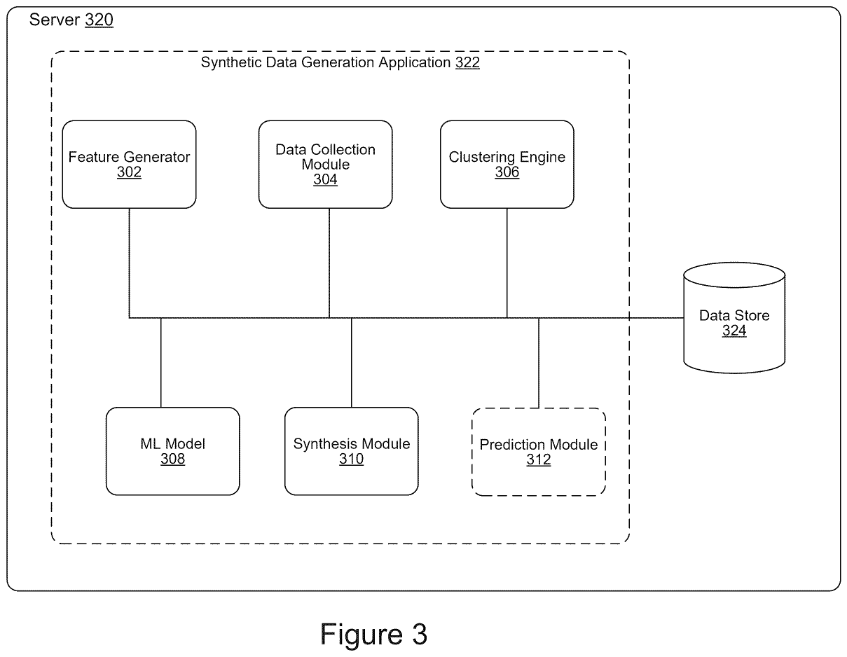

The data set may be processed based on one or more clustering processes at step 106. In some embodiments, the data clustering process such as feature-based clustering and/or time-series-based clustering may be performed. At step 108, the data set (e.g., including existing data items) may first be clustered, which is then used to output cluster time-series signals or a time-series data set based on the features of the new data item. A data signal representing a trend in a data value over a recent period of time may also be generated. At step 110, the cluster time-series signals and data signals may be combined to form the synthetic data used for the predictive model (e.g., AI/ML model). The synthetic data can simulate user behaviors/interactions and/or environmental conditions, providing insights into the new data item when real data is scarce. When the synthetic data is used as training data for the predictive model to obtain a prediction, the performance of the predictive model is improved and the prediction is enhanced. It should be noted that FIG. 1 is merely an exemplary illustration of a synthetic data generation process, operations/steps may be added and/or removed within the spirit and the scope of this disclosure. The steps of process 100 will be further detailed below with reference to FIGS. 3, 4, 5A, and 5B.

Advantageously, the present system effectively generates time series data that existing approaches have failed to deliver when such data is not available or is difficult to capture. The existing approaches may either generate a trend score within a specific range or merely provide a flat line prediction (e.g., if <80%, no data congestion), but cannot generate a realistic and reliable time series as disclosed herein. The present system therefore achieves significant improvements in model performance and accurate prediction results.

In some embodiments, the time series data generated by the present system may combine both historical information from the set of data items and data trend information of the new data item, leading to a more accurate prediction result than that of existing predictive models. For example, the present approach may be used to generate synthetic historical network traffic patterns for new software applications introduced into an enterprise environment. Using known network traffic patterns for software applications having similar features, synthetic traffic data over a period of time can be constructed using the presently described techniques, and then used to train a machine learning model or otherwise predict future network traffic patterns for similar software applications. As another example, the present approach may be employed to generate potential historical sales data for a new product to highlight how the sales would have appeared if the product had been released earlier. The data takes all the seasonal and average sale demands into consideration to generate a realistic time series history. In other words, to enhance the demand forecasting for a new product, the combined time series data may identify patterns such as seasonality, trends, and cycles, uncover complex relationships/interactions between economic factors, consumer behavior, etc., and further tell the changes of patterns and relationships over time. While domain-specific data may be used to generate the synthetic or combined data series in an example use case, the present approach itself is not limited to any specific domain or industry. The present data-driven approach may further ensure that end-to-end solutions can be applied without human intervention in the entire process, which facilitates unbiased and data-centric prediction results.

### System Implementation

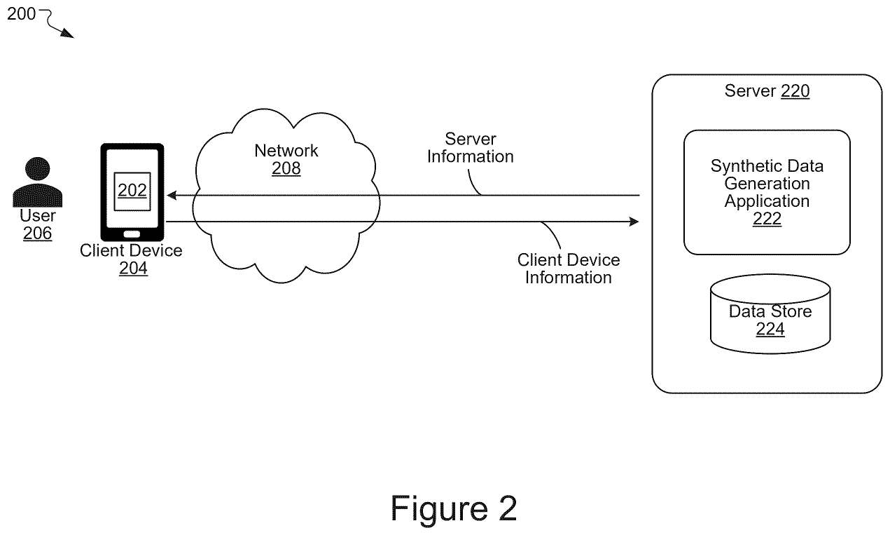

FIG. 2 illustrates an example synthetic data generation system 200, according to some embodiments. By way of example and not limitation, the methods described herein (e.g., process 100 in FIG. 1) may be executed, at least in part, by a software application 202 running on client device 204 operated by a user 206. By way of example and not limitation, client device 204 can be a smartphone device, a tablet, a tablet personal computer (PC), or a laptop PC. In some embodiments, client device 204 can be any suitable electronic device connected to a network 208 via a wired or wireless connection and capable of running software applications like software application 202. In some embodiments, client device 204 can be a desktop PC running software application 202. In some embodiments, software application 202 can be installed on client device 204 or be a web-based application running on client device 204. By way of example and not limitation, user 306 can be a person who intends to achieve a specific goal such as requesting a service, conducting a transaction, seeking an answer to a question, etc. For example, the user can communicate with server 220 via software application 202 residing on client device 204 to send information on data items for generating synthetic data and receive a prediction result (e.g., related to a new data item) from a predictive model trained on the synthetic data.

Network 208 can be an intranet network, an extranet network, a public network, or combinations thereof used by software application 202 to exchange information with one or more remote or local servers, such as server 220. According to some embodiments, software application 202 can be configured to exchange information, via network 208, with additional servers that belong to system 200 or other systems similar to system 200 not shown in FIG. 2 for simplicity.

In some embodiments, server 220 is configured to store, process and analyze the information received from user 206, via software application 202, and subsequently transmit in real time processed data back to software application 202. Server 220 can include a synthetic data generation application 222 and a data store 224, which each includes a number of modules and components discussed below with reference to FIG. 3. According to some embodiments, server 220 performs at least some of the operations discussed in the methods described herein (e.g., process 100 in FIG. 1). In some embodiments, server 220 can be a cloud-based server.

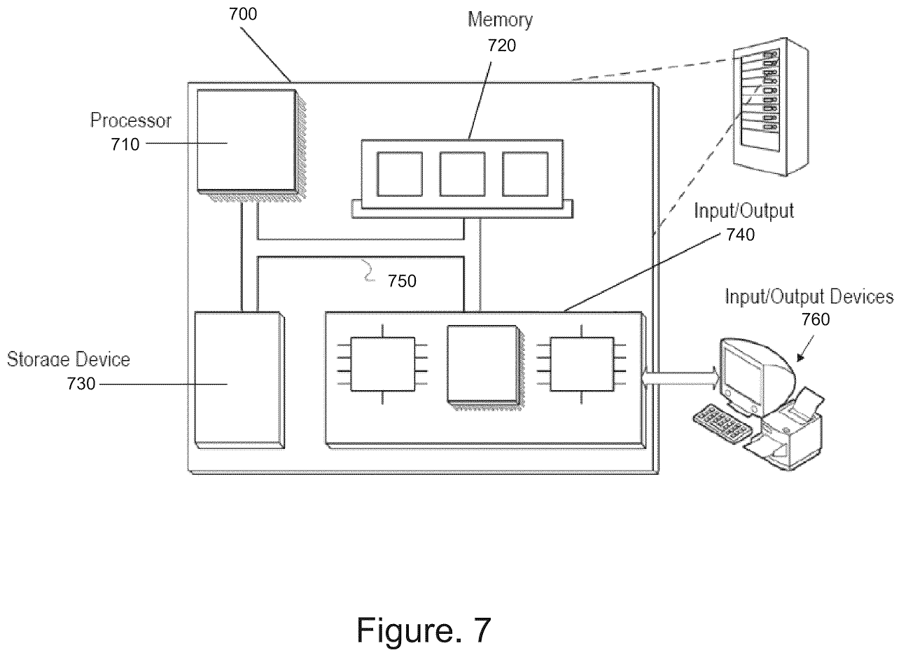

In some embodiments, FIG. 3 depicts selective components of server 220 used to perform the functionalities described herein, for example, operations of process 100. Server 220 may include additional components not shown in FIG. 3. These additional components are omitted merely for simplicity. These additional components may include, but are not limited to, computer processing units (CPUs), graphical processing units (GPUs), memory banks, graphic adaptors, external ports and connections, peripherals, power supplies, etc., required for the operation of server 220. An exemplary computer system is shown in FIG. 7. The aforementioned additional components, and other components, required for the operation of server 220 are within the spirit and the scope of this disclosure.

In the illustrated embodiment of FIG. 3, server 220 includes a synthetic data generation application 222 and a data store 224. Synthetic data generation application 222 in turn includes one or more modules responsible for processing and analyzing the information received by server 220. For example, the modules/engines in synthetic data generation application 222 may have access to the information of data items provided by user 206 and received from heterogeneous sources, generate synthetic data, and provide the synthetic data for use by a predictive model to generate predictions related to one or more data items.

In some embodiments, synthetic data generation application 222 of server 220 includes a feature generator 302, a data collection module 304, a clustering engine 306, an ML model 308, a synthesis module 310, and an optional prediction module 312. In some embodiments, synthetic data generation application 222 of server 220 may include only a subset of the aforementioned modules or include at least one of the aforementioned modules. Additional modules may be present on other servers communicatively coupled to server 220. For example, prediction module 312 is optional (depicted in a dash-lined box) as it may be deployed on separate servers (including server 220) that are communicatively coupled to each other. All possible permutations and combinations, including the ones described above, are within the spirit and the scope of this disclosure.

In some embodiments, each module of synthetic data generation application 222 may store the data used and generated in performing the functionalities described herein in data store 224. Data store 224 may be categorized in different libraries (not shown). Each library stores one or more types of data used in implementing the methods described herein. By way of example and not limitation, each library can be a hard disk drive (HDD), a solid-state drive (SSD), a memory bank, or another suitable storage medium to which other components of server 220 have read and write access.

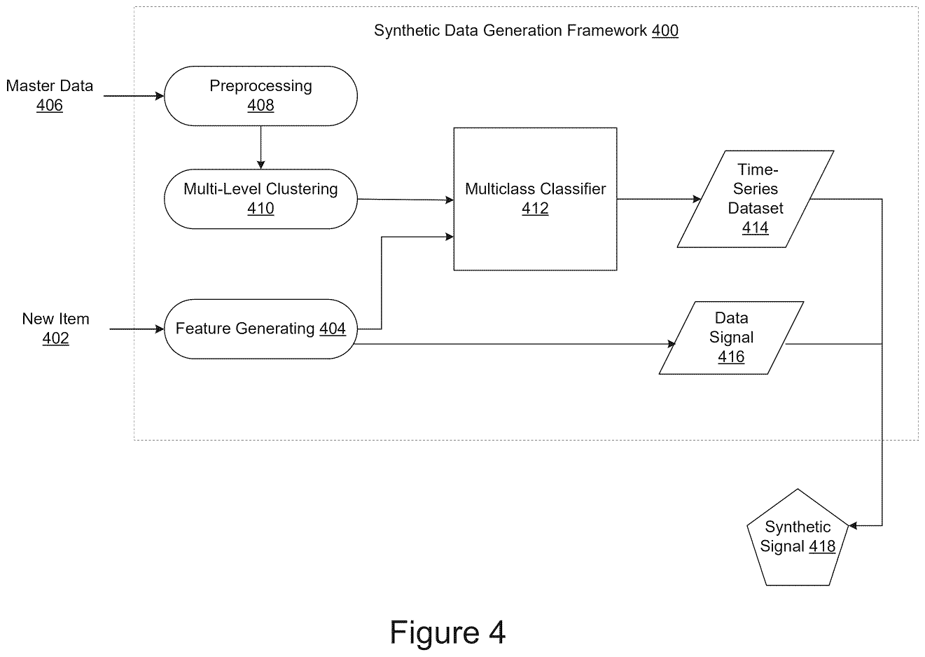

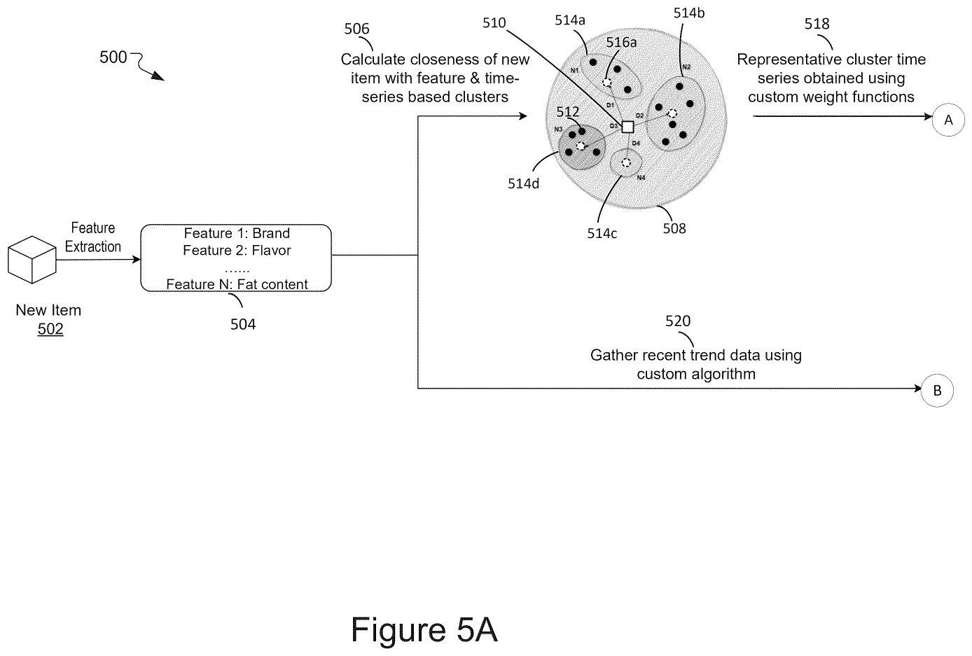

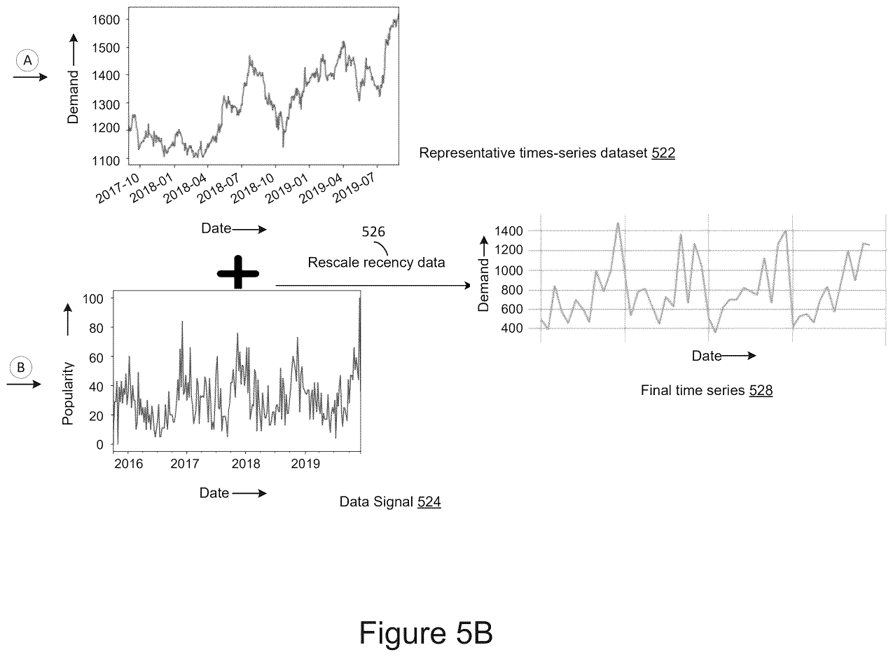

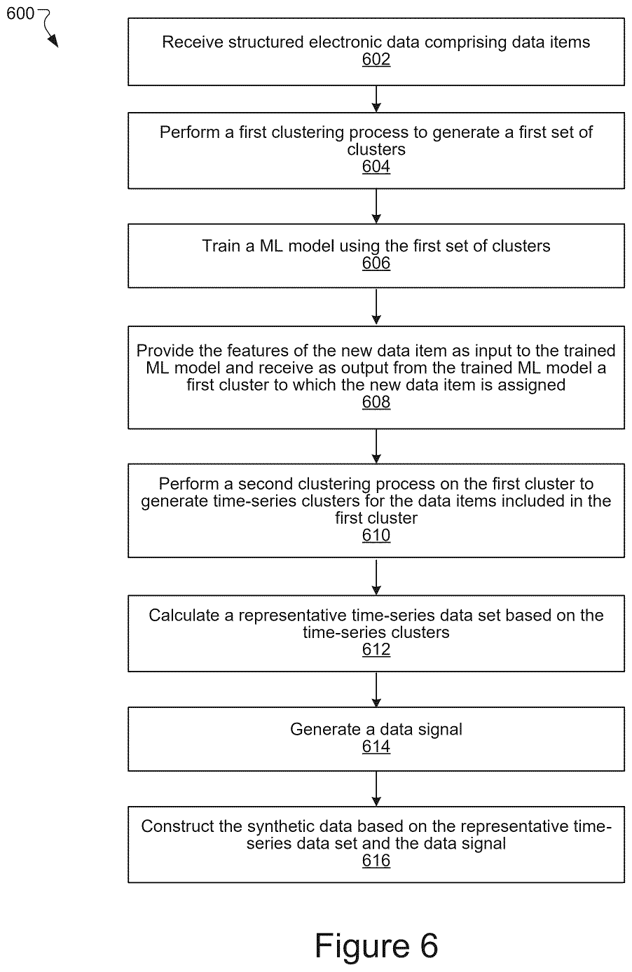

Although not shown in FIG. 3, server 220 may include a user interface engine to generate data for display on the client device 204, an AI subsystem to provide chatbot service or assistance to users, etc. For brevity and clarity, these backend supporting components will not be described separately in this disclosure. Also, various functionalities performed by synthetic data generation application 222 of server 220 in communication with client device 204 as well as other components of system 200 will mainly be described in accordance with the framework shown in FIG. 4 and with reference to other FIGS. 5A-6.

### Synthetic Data Generation Solution

FIG. 4 illustrates an example framework 400 for generating synthetic data, according to some embodiments. The synthetic data may be training data prepared for a predictive AI/ML model. The synthetic data may also include historical data used for configuring or otherwise in a forecasting model. Framework 400 addresses the data limitation (e.g., lack of training data, incomplete data) associated with a predictive AI/ML model, by applying a comprehensive data-driven solution to utilize limited information to generate a reliable synthetic data signal. The predictive model may then use the generated synthetic data (e.g., trained on the synthetic data) for estimation and prediction using traditional methods. In some embodiments, the present system may combine a representative time-series data set determined from data items (e.g., using one or more clustering processes) with a data signal representing a data trend to generate a synthetic time-series data. Although some example use cases (e.g., synthetic data generation associated with software application network traffic or a new product) may be included in the description of FIG. 4 below for brevity and clarity, the synthetic data generation framework 400 described herein can be applied to prepare reliable and enhanced data for use by any other predictive models.

The synthetic data generation may start from receiving information about a new data item 402 (e.g., via client device 204 from user 206) and extracting or deriving features of the new data item at 404. The features may include core features and/or new features of new data item 402. The core features include fundamental attributes that define data item 402's primary functionality, essential specifications, competitive benchmarking features, etc. The new features are features aiming to address gaps, provide innovative functionalities, leverage ML or AI operations, enhance data security, integrate with other systems, etc. These features may be part of the input that is fed into ML model 308 (e.g., multiclass classifier 412) to train ML model 308 to generate the synthetic data.

In some embodiments, feature generator 302 of synthetic data generation application 222 may be a tool or algorithm used to extract or derive features of the new data item at 404. Feature generator 302 may perform a comprehensive understanding of the domain and structure of the received data, transform the data (e.g., scaling, encoding), and identify and evaluate important data patterns to create meaningful features. In some embodiments, feature generator 302 may be AI-driven to automate feature engineering. The feature extraction is useful for streamlining the data clustering workflow (as described below) and making the data preparation process for predictive models more efficient.

As shown in framework 400, the present system may also collect and process data (e.g., master data 406) of other data items to simulate plausible data patterns. This processed data along with the features of the new data item may serve as input fed into ML model 308 (e.g., multiclass classifier 412) to generate the synthetic data. In some embodiments, a set of other data items are comparable data items selected based at least in part on similarities with the new data item. In some embodiments, data collection module 304 and clustering engine 306 of synthetic data generation application 222 may communicate with ML model 308 to prepare data (e.g., training data) for use in a predictive model.

Data collection module 304 may determine master data 406 for the set of data items. Master data 406 is a structured and comprehensive set of electronic data describing the core attributes (e.g., exogenous features) of comparable data items. Master data 406 may include the core features of all the data items that are important in defining the similarities and differences between data items, benefiting the determination of patterns for the data items and the prediction relevant to a new or variant data item. For example, the master data set for network-enabled software applications similar to new software applications may include type of application (e.g., word processing, data backup, etc.), types of data input, types of data output, network access capabilities, bandwidth usage restrictions, and so on. As another example, the master data set for products similar to a new product may include product identification, categorization, technical specifications (e.g., dimensions, performance metrics), descriptive attributes (e.g., color, brand, and manufacturing details), pricing information, sales and market data (e.g., sales volumes and regions, consumer demographics and preferences), supply chain data, lifecycle data (e.g., version, launch dates, maintenance timelines), etc. Master data 406 may include data in various formats such as time series data (e.g., sales data), text (e.g., product description), image data (e.g., descriptive attributes), etc.

Data collection module 304 may preprocess the data (e.g., master data 406) in 408 based on cleaning, transforming, and structuring the data to enhance the quality and relevance of master data 406 that is fed into ML model 308 (e.g., multiclass classifier 412). In some embodiments, data collection module 304 may collect data of the set of data items from heterogeneous computing sources (e.g., internal systems, competitor data, third-party databases) and perform cleaning operations to remove duplicates or irrelevant entries, handle missing data, correct inconsistencies in data formats, etc. Data collection module 304 may convert the unstructured data into structured data to refine master data 406. For example, in network-enabled software applications similar to new software applications, data collection module 304 may determine structured data (e.g., in the format of Javascript object notation (JSON), comma separated values (CSV), flow export formats, etc.) for collected network data such as data volume, data transfer rate, round-trip time, packet loss, bandwidth usage, etc. As another example, data collection module 304 may create structured tables for all the similar stock keeping units (SKUs) associated with similar products, in connection with their respective time series demand data. Data collection module 304 may also split text data into words, encode categorical data (e.g., converting non-numeric attributes into numerical format), identify and address anomalies in the data, etc. Other preprocessing operations, including the ones described above, are within the spirit and the scope of this disclosure.

### Multi-Level Clustering

The preprocessed master data 406 may then be passed to clustering engine 306 to perform multi-level clustering at 410 based on the features of new data item 402 and the training of ML model 308. In some embodiments, the multi-level clustering may include a feature-based clustering process and a time-series-based clustering process, operated on the set of data items. Clustering engine 306 may determine a feature-based cluster (e.g., the closest cluster to which new data item 402 is assigned) and create time-series-based clusters from inside the feature-based cluster. A representative time-series dataset may be determined from the time-series-based clusters, which along with a data signal representing a data trend can form the synthetic data used for a predictive model.

The feature-based clustering process or the first clustering process may be applied to the set of data items to uncover data patterns associated with the data items and create meaningful, actionable groupings of data items (e.g., based on shared features) for further analysis. Clustering engine 306 may transform the preprocessed master data 406 into a set of features, and compress the features into a smaller number of fields or categorize the features with minimal loss of information for optimized processing. This may reduce feature dimensions and facilitate the clustering process. Clustering engine 306 may then segregate the data items into an optimal number of clusters (e.g., a first set of clusters) based on the similarities and differences in the features associated with the data items. For example, clustering engine 306 may identify key features relevant to clustering (e.g., using one-hot encoding or embedding), normalize the identified features, and calculate one or more distance or similarity measurements (e.g., Euclidean distance, cosine similarity, hamming distance, etc.) to evaluate how similar the data items are. Clustering engine 306 may categorize or group the data items based on the calculated measurements to determine the first set of clusters.

Model 308 may be trained on the clustering information of the feature-based clusters (e.g., the first set of clusters). The trained cluster may be provided with the features of the new data item to identify and output the closest feature-based cluster (e.g., a first cluster) to which new data item 402 is assigned. In some embodiments, model 308 may be a multiclass classifier 412 shown in FIG. 4. A multiclass classifier is an ML model designed to classify instances into one of three or more distinct classes. In some embodiments, multiclass classifier 412 may include an extremely randomized trees (extra trees) classifier. The extra trees classifier is an ensemble ML learning method that builds multiple decision trees (e.g., based on random feature split at each tree node) and combines the predictions from each tree (e.g., majority voting for classification) to improve the classification performance. In some embodiments, the extra trees may be trained to extract feature importance scores for each feature of the data items, which can be used to select the top N features or to weigh the features of the data items. Clustering engine 306 may perform clustering on the reduced N features or importance-weighted features based on one or more distance or similarity metrics with the features of new data item 402. For example, clustering engine 306 may identify the closest feature-based cluster based on an Euclidean distance or a Manhattan distance to the features of new data item 402.

In an example use case of a network-enabled software application (e.g., 402), at the feature-based clustering stage, the output “closest” feature-based cluster may include software applications that are most similar to the new application on identified key features (e.g., functionalities, technical stacks, user interfaces, etc.) based on distance/similarity metrics. As another example, the present approach can be designed to use both historical and recent trend data to forecast the demand for a new product. The output cluster at this feature clustering stage may include products with similar key features (e.g., technical specifications, descriptive attributes, etc.). Feature-based clustering allows comparable data items to be selected based on advanced ML-based algorithms without manual operations.

When the closest feature-based cluster or the first cluster was identified by multiclass classifier 412 (e.g., extra trees classifier) for new data item 402, one or more time-series-based clusters (also referred to as time-series clusters) may be determined from inside this specific feature-based cluster through a second clustering process using specialized metrics such as dynamic time warping (DTW), Euclidean distance, correlation, etc. In some embodiments, clustering engine 306 may apply DTW to generate the time-series clusters. Typically, clustering engine 306 may align time-series data/sequences (e.g., by normalizing/scaling the time-series values and/or filling missing values using interpolation), compute DTW distances between every pair of time-series sequences to determine a distance matrix, and apply a clustering algorithm (e.g., identify representative sequences as cluster centers) based on the distance matrix. In some embodiments, for each generated time-series cluster, clustering engine 306 may calculate one of a middle point, an average, or a centroid of the cluster to represent the mean feature demonstrated by that cluster, and, additionally, take the mean of all the time-series sequences/signals inside each time-series cluster to generate its associated time-series sequence for the cluster.

In other words, at the time-series-based clustering stage, upon receiving the input of the first cluster (e.g., the “closest” feature-based cluster) that includes certain comparable data items and associated features, clustering engine 306 may create one or more time-series clusters for these comparable data items, determine centroids of the time-series clusters, and generate an associated time-series sequence for each created time-series cluster to show its representative patterns. Continuing with the above network-enabled software application examples, clustering engine 306 may generate time-series clusters for the network traffic patterns demonstrated by software applications similar to the new application. Examples of time-series clusters may include a cluster for traffic volume patterns, a cluster for latency patterns, a cluster for protocol usage patterns, a cluster for traffic anomalies, etc. The associated time-series sequence corresponding to each time-series cluster may respectively show peak traffic hours, sudden traffic spikes, low/high latency, burst latency, transmission control protocol (TCP) connection patterns, distributed denial of service (DDoS) attacks, etc. As to the new product demand forecasting example, clustering engine 306 may generate time-series clusters for the sale patterns demonstrated by similar products such as a cluster for seasonable products with stable sales, a cluster for highly variable products, etc.

### Representative Time-Series Data Set (Cluster Time-Series) Generation

The associated time-series sequence generated for each time-series cluster by clustering engine 306 and ML model 308 can be used by synthesis module 310 to generate a representative time-series data set, which may be combined with a data signal of new data item 402 (also generated by synthesis module 310 as described below) to obtain synthetic time-series data for use by a predictive model. The representative time-series data set (also referred to as cluster time-series) may represent the data pattern (e.g., features) available and identified from data items (e.g., network traffic data for software applications, historical sales data for similar products) comparable to new data item 402. The data signal may represent a trend relevant to new data item 402 in a recent period of time. In some embodiments, the synthetic time-series data may be training data used by the predictive model (e.g., estimating network traffic patterns for a software application). In other embodiments, the synthetic data may also be historical data for use with a forecasting model (e.g., forecasting the demand for a new product).

In some embodiments, synthesis module 310 may first compute a coordinate distance dᵢ (e.g., Euclidean distance) between the features of new data item 402 and a representation of the feature of each time-series cluster (e.g., the centroid of the time-series cluster). This can provide an estimation of how close new data item 402 is to each of the time-series clusters created by clustering engine 306.

Based on the number of data items inside each time-series cluster nᵢ (e.g., the number of known software applications, the number of product SKUs, etc.) and the distance from the new data item dᵢ, synthesis module 310 may assign a weight to each time-series cluster, for example, using the following custom weight formula:

$${Weight}_{i} = \frac{{n}_{i} / {d}_{i}}{{\sum }_{j = 1}^{m} ( {n}_{j} / {d}_{j} )} \qquad ( 1 )$$

Here, all the weight; add up to one. Other weight formulas may also be possible. Once the weight; is assigned to each time-series cluster, each associated time-series sequence for the cluster determined by clustering engine 306 can be weighted by the weightᵢ. Synthesis module 310 may then calculate the mean of [weightᵢ×(the associated time-series sequence for cluster nᵢ)] for all m clusters to obtain the representative time-series data set or cluster time-series 414, which represents an overall data pattern identified from the data items in all the time-series clusters.

### Data Signal Generation

Next, synthesis module 310 in communication with other components of synthetic data generation framework 400 may generate a data signal 416 for new data item 402. A data signal is a time series sequence that indicates a trend in a data value over a recent period of time. The data trend may reflect the level of interest (e.g., network traffic), demand, or engagement of a data item (e.g., a software application). This data signal can be useful in decision-making processes such as ranking, recommending, etc. In some embodiments, synthesis module 310 may use all the combinations of identified features of new data item 402 and the trend data inside a custom-tailored algorithm to generate data signal 416 in a range (e.g., between 0 and 100).

The custom-tailored algorithm may be applied to collect relevant interaction data, determine measurable metrics such as volume-based metrics (e.g., total sales, views, clicks), engagement-based metrics (e.g., repeat visits, total time spent on a data item), etc., and perform various analyses such as sentiment analysis, trend analysis, etc. For example, the present system can retrieve data, including reports of computer network traffic or opinions about a new product, from a variety of sources (e.g., enterprise network logs, social media platforms, etc.). The present system may process the collected data using one or more ML models (e.g., an open-source language model) to categorize the data (e.g., reports, opinions) as positive, negative, or neutral. For computer network traffic, the ML model may be a model trained to identify issues with computer network performance based on traffic patterns. For product information, the ML model may be a language model trained to identify consumer sentiment. Based on this analysis, the present system may assign a representative score (e.g., ranging from 0 to 100) at a particular point in or period of time represented by the analyzed data. The nature of the score can vary based on the use case, and in some embodiments can represent the overall performance of a computer network or the overall reception of a product. Multiple scores can be calculated at different points in time, and the scores can subsequently be used to generate a final data signal 416. The present algorithm is specifically designed and fine-tuned to utilize various types of data collected through various means (e.g., social media, web channels, open source forums) to maximize efficiency, accuracy, or performance for qualifying a data trend.

In the field of network security threat detection, the present system may continuously monitor cybersecurity discussion forums, social media platforms, or dark web chatter where users discuss newly emerging security vulnerabilities or malware attacks, and extract the data related to network traffic from these discussions and send the data to an LLM-based threat intelligence system. The LLM can then analyze sentiment and urgency, determining whether the discussions indicate a high-risk security threat or just general cybersecurity discussions, which results in a threat level score (e.g., 0-100) that quantifies the severity and potential impact of the reported issue. This helps prioritize responses to emerging threats based on public perception and expert discussions. In another example, the present system may extract text from a customer support forum where users are discussing a newly released ice cream flavor. The present system may then use an intelligence model to process these discussions to determine a popularity score of the ice cream, evaluating a product's popularity trend.

The generated data signal 416 represents a trend in a data value. For example, data signal 416 may include a popularity signal. However, unlike a single popularity score showing whether a new data item is popular or not (e.g., as compared to a predefined threshold) generated using existing methods, data signal 416 may be a time-series sequence that represents the rise and fall in trend of all the identified features of new data item 402 in recent times, thereby representing the recency information for new data item 402.

In some embodiments, one or more data signals may be generated in the process. Synthesis module 310 may assign a weight to each of the data signals based on a custom weight function and determine a final data signal from the weighted signals. For example, when generating data signal 416 for use in predicting the demand for a new product, a weight formula may be:

$$WeightFunction = \frac{Mean}{Average Demand Interval} \qquad ( 2 )$$

In some embodiments, synthesis module 310 may use a WeightFunction that assigns more weights to the non-intermittent signals than intermittent signals to increase signal reliability. An intermittent signal is irregular in nature, which appears and disappears over time rather than maintaining a continuous presence. According to the WeightFunction, more weight or priority may be given to a regular signal over an intermittent signal (e.g., more weight assigned to regularly reported data instead of erratic updates) to improve accuracy, reliability, and system performance.

### Synthetic Signal Generation

Synthesis module 310 may combine representative time-series data set 414 and data signal 416 to create a synthetic signal 418, which will be used by a prediction module 312 for use in a predictive model. For example, to prepare the synthetic signal 418 as training data for a predictive model, synthesis module 310 may rescale the entire data signal 416 (e.g., a time series) to the mean or average of the representative time-series data set 414, and take the mean signal of the rescaled data signal 416 and the representative time-series data set 414. The resultant signal 418 is the synthetically generated data.

Upon receiving the input of synthetic signal 418, prediction module 312 may use it as a training data set in one or more predictive models. For example, in a computer vision system where diverse scenarios or variations of an image cannot be obtained or captured, synthetic data may be generated to create such scenarios and variations, thereby enabling the transformations required for accurate prediction and improving the predictive model trained on this synthetic signal. In some cases, this synthetic signal may also be used as historical data in a forecasting model. For example, prediction module 312 may apply band forecasting to generate the forecast of sales for a new product based on synthetic historical signal 418. A predictive model may be an autoregressive integrated moving average (ARIMA) model, exponential smoothing (ETS) model, long short-term memory networks (LSTM), etc. The synthetic signal 418 can also include synthetic computer/network resource usage data to predict cyberthreat coverage, synthetic patient data to predict disease outbreaks, or used to simulate network connection failures to predict network connection delays or system recovery needs, etc.

Using synthetic data 418 in training a predictive model (e.g., AI/ML model) is a valuable strategy that can address challenges such as data scarcity, privacy concerns, and class imbalances. Prediction module 312 may use synthetic data 418 to augment existing datasets or create entirely new datasets when real-world data needed for the predictive model is limited or hard to capture. Since synthetic data 418 is generated without using sensitive or personal information, prediction module 312 may train a predictive model on sensitive areas (e.g., healthcare, finance) where using real data might be restricted. Prediction module 312 may also use synthetic data 418 to help address class imbalances in the training data by generating more instances of the underrepresented classes, which is especially useful in scenarios such as fraud detection or rare disease prediction as synthetic data 418 can ensure that the model is exposed to enough examples of the rare events. When an AI/ML model is trained on synthetic data 418 that allows for the creation of diverse scenarios or variations of the same data, the robustness of the AI/ML model is improved because the model is exposed to different types of data. For example, in computer vision, synthetic data 418 might involve generating new images by applying transformations like rotation, zoom, or color adjustments to existing images.

In some embodiments, synthetic data 418 may also provide plausible past scenarios based on current trends and domain-specific models, which is particularly useful in forecasting new or emerging data items by prediction module 312. Synthetic data 418 may augment existing datasets with additional variations and edge cases, improving the ability of prediction module 312 to handle uncertainty and variability in future forecasts. Synthetic data 418 may also simulate future events (e.g., new features, new technologies, policy changes) that have not yet occurred but are important to forecast. By providing complex, high-dimensional rich data that simulate the data variability and nuances required for accurate forecasting, synthetic data 418 can be fed into prediction module 312 to significantly improve the forecasting performance.

### Example Data Preparation Workflow

FIGS. 5A and 5B illustrate an example workflow 500 of generating synthetic demand time series data, according to some embodiments. The present approach can be designed to use both historical and recent trend data to forecast the demand for a new data item (e.g., a new product). In the example of these figures, the new data item for which the synthetic historical demand data is supposed to generate is a new yogurt product 502. Forecasting models rely on historical data to identify patterns, trends, and relationships that can be extrapolated into future predictions. Without historical data, the forecasting models cannot understand seasonal patterns, long-term trends, and cyclic behaviors of new yogurt product 502, leading to unreliable forecasts. Workflow 500 helps overcome the data limitations of new product forecasting by generating synthetic historical time series data.

Workflow 500 starts from the feature extraction performed (e.g., by feature generator 302 in FIG. 3) on the new yogurt 502, which may result in a total of N features such as brand, flavor, . . . fat content in 504. Data of other data items (e.g., other yogurt products) are collected and master data (not shown) associated with the data items are created (e.g., by data collection module 304 in FIG. 3). Multi-level clustering is conducted (by clustering engine 306 and model 308 in FIG. 3) on the master data of other yogurts based on the extracted N features of the new yogurt 502. The multi-level clustering may include feature-based clustering and time-series-based clustering. In some embodiments, the closeness of new yogurt product 502 with feature-based and time-series-based clusters may be measured in 506.

In the example of FIG. 5A, a circle 508 represents a selected feature-based cluster where new yogurt 502 lies. In some embodiments, this feature-based cluster or first cluster 508 may be selected to include the yogurt products that have key features closest to the features of new yogurt 502 (e.g., based on one or more distance measurements). As depicted, new yogurt 502 is represented by a square 510 in the center of feature-based cluster 508, and similar/comparable yogurt products are represented by black dots (e.g., 512). Inside the feature-based cluster 508 (e.g., the biggest circle), time-series clusters 514a, 514b, 514c, and 514d (e.g., smaller circles/ellipses) may be created, for example, based on DTW distance measurements. Each time-series cluster 514a, 514b, 514c, or 514d may include feature data in the form of time-series sequences for the comparable yogurt products (e.g., black dots). In some embodiments, the mean or centroid of each time series cluster 514a, 514b, 514c, and 514d may be calculated to represent the mean feature demonstrated by that cluster, as shown in dash-lined dots. For example, the mean/center of time series cluster 514a is 516a. A distance between the new product (e.g., central square 510) and the mean/center of each time series cluster (e.g., dash-lined dots including 516a) can then be calculated, as shown in the lines between the square 510 and dash-lined dots. Based on such distances, in 518, a representative cluster time-series dataset can be determined using a custom weight function (e.g., formula 1). Additionally, in 520, recent trend data is also gathered and applied to a custom algorithm to determine a data signal.

Referring now to FIG. 5B, a cluster time series or representative time-series dataset is shown in 522 and a data signal is shown in 524. The representative time-series dataset 522 is a time-series sequence that represents historical demand data for yogurt products other than the new yogurt 502. The data signal 524 in this example is a time-series sequence that represents the recency information of new yogurt 502. The recency data may be rescaled in 526. The rescaled data signal 524 and representative time-series dataset 522 may then be combined to determine a final time series 528, which is synthetic data that can be used for forecasting the new yogurt 502. In this example, workflow 500 can provide both historical data and recency data of a new product to a forecasting model for further forecasting of the new product. This workflow does not rely on the manual selection of comparable products and can be applied in any technical domain, thereby reducing forecasting errors and improving the forecasting performance.

### Flowchart

FIG. 6 illustrates a flowchart 600 of generating synthetic data, according to some embodiments. The synthetic data may serve as training data for an AI/ML model, especially when the real data is scarce or cannot be captured. In some embodiments, various components of synthetic data generation application 322 of a server 220 along with other system components (e.g., client device 204) may work together to implement the operations of flowchart 600. In some embodiments, synthetic data generation application 322 includes a feature generator 302, a data collection module 304, a clustering engine 306, an ML model 308, a synthesis module 310, and an optional prediction module 312.

At step 602, data collection module 304 may receive structured electronic data of a set of data items. Each data item includes various features. The structured data may include master data, and master data may be preprocessed (e.g., cleaned, transformed). In some embodiments, data collection module 304 may also receive a new data item. Data collection module 304 may communicate with feature generator 302 to extract features from the data of the new data item and/or from the data associated with the set of data items. The preprocessing of master data may include analyzing the features of data items to determine determining the similarities and differences.

At step 604, clustering engine 306 may perform a first clustering process to generate a first set of clusters based on similarities and differences of the features in the data items. In some embodiments, the first clustering process is a feature-based clustering process. For example, clustering engine 306 may identify a set of features from the features of the data items, normalize the identified features, determine a distance or similarity measurement, and categorize the data items based on the distance to determine the first set of clusters.

At step 606, ML module 308 may be used to train an ML model using the first set of clusters to predict an assignment of a new data item to a cluster in the first set of clusters. At step 608, clustering engine 306 may provide the features of the new data item as input to the trained ML model and receive as output from the trained ML model a first cluster of the first set of clusters to which the new data item is assigned. In some embodiments, the ML model includes an extra trees classifier. Multiple feature importance scores are determined for the features associated with the data items included in the first set of clusters, and the cluster to which the new data item is assigned may be determined based on the feature importance scores.

At step 610, clustering engine 306 may perform a second clustering process on the first cluster to generate time-series clusters for the data items included in the first cluster. In some embodiments, the second clustering process is a time-series-based clustering process. In some embodiments, clustering engine 306 may apply DTW to generate the time-series clusters for the data items included in the first cluster.

Based on the generated time series clusters, at step 612, clustering engine 306 may communicate with synthesis module 310 to calculate a representative time-series data set based on the time-series clusters. In some embodiments, clustering engine 306 may calculate a first distance between the features of the new data item and a representation of the features of the time-series clusters. For example, a center (e.g., middle point, average) of each of the time series clusters may be determined to represent a mean feature demonstrated by the cluster. The first distance between the feature of the new data item and the center of each of the time-series clusters can be determined, which can then be used to determine the representative time-series data set. For example, a weight may be assigned to each time-series cluster based on the first distance using a first custom weight function (e.g., formula 1). A mean value of all the time-series sequences/signals inside each time-series cluster may be calculated to generate an associated time series for the cluster. The representative time-series data set can then be determined based on the weight assigned for each time-series cluster and the associated time series for each time-series cluster.

At step 614, synthesis module 310 may generate a data signal representing a trend in a data value over a recent period of time. For example, the data signal may be generated based on a second custom weight function (e.g., formula 2). An example data signal may represent the recency trend information of the new data item.

At step 616, synthesis module 310 may construct the synthetic data set based on the representative time-series data set and the data signal. For example, the data signal may be rescaled and combined with the representative time-series data set to create the synthetic data. This synthetic data can be fed into prediction module 312 (e.g., one or more predictive models) for use by the predictive models (e.g., as training data).

### Additional Consideration

In some examples, some or all of the processing described above can be carried out on a personal computing device, on one or more centralized computing devices, or via cloud-based processing by one or more servers. Some types of processing can occur on one device and other types of processing can occur on another device. Some or all of the data described above can be stored on a personal computing device, in data storage hosted on one or more centralized computing devices, and/or via cloud-based storage. Some data can be stored in one location and other data can be stored in another location. In some examples, quantum computing can be used, and/or functional programming languages can be used. Electrical memory, such as flash-based memory, can be used.

FIG. 7 is a block diagram of an example computer system 700 that may be used in implementing the technology described herein. General-purpose computers, network appliances, mobile devices, or other electronic systems may also include at least portions of the system 700. The system 700 includes a processor 710, a memory 720, a storage device 730, and an input/output device 740. Each of the components 710, 720, 730, and 740 may be interconnected, for example, using a system bus 750. The processor 710 is capable of processing instructions for execution within the system 700. In some implementations, the processor 710 is single-threaded. In some implementations, the processor 710 is a multi-threaded processor. The processor 710 is capable of processing instructions stored in the memory 720 or on the storage device 730.

Memory 720 stores information within the system 700. In some implementations, the memory 720 is a non-transitory computer-readable medium. In some implementations, the memory 720 is a volatile memory unit. In some implementations, the memory 720 is a non-volatile memory unit.

The storage device 730 is capable of providing mass storage for the system 700. In some implementations, the storage device 730 is a non-transitory computer-readable medium. In various implementations, the storage device 730 may include, for example, a hard disk device, an optical disk device, a solid-state drive, a flash drive, or some other large-capacity storage device. For example, the storage device may store long-term data (e.g., database data, file system data, etc.). The input/output device 740 provides input/output operations for the system 700. In some implementations, the input/output device 740 may include one or more network interface devices, e.g., an Ethernet card, a serial communication device, e.g., an RS-232 port, and/or a wireless interface device, e.g., an 802.11 card, a 3G wireless modem, or a 4G wireless modem. In some implementations, the input/output device may include driver devices configured to receive input data and send output data to other input/output devices, e.g., keyboard, printer, and display devices 760. In some examples, mobile computing devices, mobile communication devices, and other devices may be used.

In some implementations, at least a portion of the approaches described above may be realized by instructions that upon execution cause one or more processing devices to carry out the processes and functions described above. Such instructions may include, for example, interpreted instructions such as script instructions, executable code, or other instructions stored in a non-transitory computer-readable medium. The storage device 730 may be implemented in a distributed way over a network, such as a server farm or a set of widely distributed servers, or may be implemented in a single computing device.

Although an example processing system has been described in FIG. 7, embodiments of the subject matter, functional operations, and processes described in this specification can be implemented in other types of digital electronic circuitry, in tangibly embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible nonvolatile program carrier for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to a suitable receiver apparatus for execution by a data processing apparatus. The computer storage medium can be a machine-readable storage device, a machine-readable storage substrate, a random or serial access memory device, or a combination of one or more of them.

The term “system” may encompass all kinds of apparatus, devices, and machines for processing data, including by way of example a programmable processor, a computer, or multiple processors or computers. A processing system may include special-purpose logic circuitry, e.g., an FPGA (field programmable gate array) or an ASIC (application-specific integrated circuit). A processing system may include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a standalone program or as a module, component, subroutine, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Computers suitable for the execution of a computer program can include, by way of example, general or special purpose microprocessors or both, or any other kind of central processing unit. Generally, a central processing unit will receive instructions and data from a read-only memory, a random access memory, or both. A computer generally includes a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

Computer-readable media suitable for storing computer program instructions and data include all forms of non-volatile memory, media, and memory devices, including way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special-purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's user device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship between client and server arises by virtue of computer programs running on the respective computers and having a client-server relationship with each other.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other steps or stages may be provided, or steps or stages may be eliminated, from the described processes. Accordingly, other implementations are within the scope of the following claims.

### Terminology

The phraseology and terminology used herein are for the purpose of description and should not be regarded as limiting.

The term “approximately”, the phrase “approximately equal to”, and other similar phrases, as used in the specification and the claims (e.g., “X has a value of approximately Y” or “X is approximately equal to Y”), should be understood to mean that one value (X) is within a predetermined range of another value (Y). The predetermined range may be plus or minus 20%, 10%, 5%, 3%, 1%, 0.1%, or less than 0.1%, unless otherwise indicated.

The indefinite articles “a” and “an,” as used in the specification and in the claims, unless clearly indicated to the contrary, should be understood to mean “at least one.” The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating data items in a list, “or” or “and/or” shall be interpreted as being inclusive, i.e., the inclusion of at least one, but also including more than one, of a number or list of elements, and, optionally, additional unlisted data items. Only terms clearly indicated to the contrary, such as “only one of or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The use of “including,” “comprising,” “having,” “containing,” “involving,” and variations thereof, is meant to encompass the data items listed thereafter and additional data items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Each numerical value presented herein, for example, in a table, a chart, or a graph, is contemplated to represent a minimum value or a maximum value in a range for a corresponding parameter. Accordingly, when added to the claims, the numerical value provides express support for claiming the range, which may lie above or below the numerical value, in accordance with the teachings herein. Absent inclusion in the claims, each numerical value presented herein is not to be considered limiting in any regard.

The terms and expressions employed herein are used as terms and expressions of description and not of limitation, and there is no intention, in the use of such terms and expressions, of excluding any equivalents of the features shown and described or portions thereof. In addition, having described certain embodiments of the invention, it will be apparent to those of ordinary skill in the art that other embodiments incorporating the concepts disclosed herein may be used without departing from the spirit and scope of the invention. The features and functions of the various embodiments may be arranged in various combinations and permutations, and all are considered to be within the scope of the disclosed invention. Accordingly, the described embodiments are to be considered in all respects as only illustrative and not restrictive. Furthermore, the configurations, materials, and dimensions described herein are intended as illustrative and in no way limiting. Similarly, although physical explanations have been provided for explanatory purposes, there is no intent to be bound by any particular theory or mechanism, or to limit the claims in accordance therewith.

What is claimed is:

1. A computer-based method for generating a synthetic data set for use with a predictive model, the method comprising:
receiving, at a computing system comprising a processor and a memory, structured electronic data comprising a plurality of data items, wherein each data item comprises a plurality of features;
performing, by the processor, a first clustering process to generate a first set of clusters based on similarities and differences of the features of the data items;
training, by the processor, a machine learning (ML) model using the first set of clusters to predict an assignment of a new data item to a cluster in the first set of clusters;
receiving, at the computing system, a new data item comprising a plurality of features;
providing the features of the new data item as input to the trained ML model and receiving as output from the trained ML model a first cluster of the first set of clusters to which the new data item is assigned;
performing, by the processor, a second clustering process on the first cluster to generate a plurality of time-series clusters for the data items included in the first cluster;
calculating, by the processor, a representative time-series data set based on the plurality of time-series clusters;
generating, by the processor, a data signal representing a trend in a data value over a recent period of time; and
constructing the synthetic data set based on the representative time-series data set and the data signal.

2. The method of claim 1, wherein the first clustering process is a feature-based clustering process, and the second clustering process is a time-series-based clustering process.

3. The method of claim 1, wherein performing the second clustering process comprises applying dynamic time warping to generate the plurality of time-series clusters for the data items included in the first cluster.

4. The method of claim 1, further comprising:
for each time-series cluster in the plurality of time-series clusters, calculating, by the processor, a first distance between the features of the new data item and a representation of the features of the time-series cluster,
wherein the representation comprises a mean feature demonstrated by each of the plurality of time-series clusters.

5. The method of claim 4, wherein calculating the representative time-series data set comprises:
assigning a weight to each time-series cluster based on the first distance using a first custom weight function;
calculating a mean value of time-series sequences included in each time-series cluster to generate an associated time series for the time-series cluster; and
determining the representative time-series data set based on the weight assigned to each time-series cluster and the associated time series calculated for each time-series cluster.

6. The method of claim 1, wherein the data signal is generated using a custom weight function.

7. The method of claim 1, wherein performing the first clustering process comprises:
identifying a set of features from the plurality of features associated with the plurality of data items;
normalizing the identified features;
determining a second distance to measure similarity between the features of the new data item and the normalized features of each of the plurality of data items; and
categorizing the plurality of data items based on the second distance.

8. The method of claim 7, further comprising:
extracting a plurality of feature importance scores associated with the features of the data items in the first set of clusters,
wherein receiving as input from the trained ML model the first cluster to which the new data item is assigned is based on the feature importance scores.

9. The method of claim 1, further comprising preprocessing the received data of the plurality of data items.

10. The method of claim 1, wherein constructing the synthetic data set comprises:
rescaling the data signal; and
combining the rescaled data signal and the representative time-series data set.

11. A computing system for generating a synthetic data set for use with a predictive model comprising:
a processor; and
a memory in communication with the processor and comprising instructions which, when executed by the processor, program the processor to:
receive structured electronic data comprising a plurality of data items, wherein each data item comprises a plurality of features;
perform a first clustering process to generate a first set of clusters based on similarities and differences of the features of the data items;
train a machine learning (ML) model using the first set of clusters to predict an assignment of a new data item to a cluster in the first set of clusters;
receive a new data item comprising a plurality of features;
provide the features of the new data item as input to the trained ML model and receive as output from the trained ML model a first cluster of the first set of clusters to which the new data item is assigned;
perform a second clustering process on the first cluster to generate a plurality of time-series clusters for the data items included in the first cluster;
calculate a representative time-series data set based on the plurality of time-series clusters;
generate a data signal representing a trend in a data value over a recent period of time; and
construct the synthetic data set based on the representative time-series data set and the data signal.

12. The system of claim 11, wherein the first clustering process is a feature-based clustering process, and the second clustering process is a time-series-based clustering process.

13. The system of claim 11, wherein, to perform the second clustering process, the instructions further program the processor to apply dynamic time warping to generate the plurality of time-series clusters for the data items included in the first cluster.

14. The system of claim 13, wherein the instructions further program the processor to:
for each time-series cluster in the plurality of time-series clusters, calculate, by the processor, a first distance between the features of the new data item and a representation of the features of the time-series cluster,
wherein the representation comprises a mean feature demonstrated by each of the plurality of time-series clusters.

15. The system of claim 14, wherein to calculate the representative time-series data set, the instructions further program the processor to:
assign a weight to each time-series cluster based on the first distance using a first custom weight function;
calculate a mean value of time-series sequences included in each time series cluster to generate an associated time series for the time-series cluster; and
determine the representative time-series data set based on the weight assigned to each time series cluster and the associated time series calculated for each time-series cluster.

16. The system of claim 11, wherein the data signal is generated using a second custom weight function.

17. The system of claim 16, wherein, to perform the first clustering process, the instructions further program the processor to:
identify a set of features from the plurality of features associated with the plurality of data items;
normalize the identified features;
determine a second distance to measure similarity between the features of the new data item and the normalized features of each of the plurality of data items; and
categorize the plurality of data items based on the second distance.

18. The system of claim 17, wherein the instructions further program the processor to:
extract a plurality of feature importance scores associated with the features of the data items in the first set of clusters,
wherein receiving as input from the trained ML model the first cluster to which the new data item is assigned is based on the feature importance scores.

19. The system of claim 11, wherein the instructions further program the processor to:
preprocess the received data of the plurality of data items.

20. A computer program product for generating a synthetic data set for use with a predictive model, the computer program product comprising a non-transitory computer-readable medium having computer readable program code stored thereon, the computer readable program code configured to:
receive structured electronic data comprising a plurality of data items, wherein each data item comprises a plurality of features;
perform a first clustering process to generate a first set of clusters based on similarities and differences of the features of the data items;
train a machine learning (ML) model using the first set of clusters to predict an assignment of a new data item to a cluster in the first set of clusters;
receive a new data item comprising a plurality of features;
provide the features of the new data item as input to the trained ML model and receive as output from the trained ML model a first cluster of the first set of clusters to which the new data item is assigned;
perform a second clustering process on the first cluster to generate a plurality of time-series clusters for the data items included in the first cluster;
calculate a representative time-series data set based on the plurality of time-series clusters;
generate a data signal representing a trend in a data value over a recent period of time; and
construct the synthetic data set based on the representative time-series data set and the data signal.
